(19) United States
(12) Patent Application Publication
(10) Pub. No.: US 2013/0223703 A1
(43) Pub. Date: Aug. 29, 2013

(54) MEDICAL IMAGE PROCESSING APPARATUS

(71) Applicants: Kabushiki Kaisha Toshiba, (US); Toshiba Medical Systems Corporation, (US)

(72) Inventors: Yasuko FUJISAWA, Nasushiobara-shi (JP); Yoshihiro IKEDA, Sakura-shi (JP)

(73) Assignees: Toshiba Medical Systems Corporation, Otawara-shi (JP); Kabushiki Kaisha Toshiba, Tokyo (JP)

(21) Appl. No.: 13/774,300

(22) Filed: Feb. 22, 2013

(30) Foreign Application Priority Data
Feb. 24, 2012 (JP) 2012-038584

(51) Int. Cl. G06T 7/00

(52) U.S. Cl. CPC G06T 7/0012
USPC 382/128

(57) ABSTRACT

The storage stores three-dimensional image data at a plurality of time points indicating the flexible site of a biological body. A reconstruction processor subjects the projection data to reconstruction processing to generate three-dimensional image data regarding the flexible site for each of a plurality of timing points. An extracting part extracts a plurality of construction sites constructing the flexible site from the image data. An analyzing part calculates positional information indicating the position of the first site in the plurality of construction sites extracted from the image data at the first timing point, and the position of the first site extracted from the image data at the second timing point. An image processor generates a plurality of medical images indicating temporal changes in the relative position of the second site in the plurality of construction sites to the first site based on the positional information. A display controller causes a display to display the plurality of medical images along the time sequence.

### CROSS-REFERENCE TO RELATED APPLICATION

This application is based upon and claims the benefit of priority from Japanese Patent Application No. 2012-038584, filed on Feb. 24, 2012; the entire contents of which are incorporated herein by reference.

### FIELD

The embodiment relates to the technology of a medical image processing apparatus for generating medical images.

### BACKGROUND

Medical image processing apparatuses exist for displaying three-dimensional image data collected by medical image diagnostic apparatuses. The medical image diagnostic apparatus herein includes an X-ray Computer tomography (CT) apparatus or Magnetic resonance Imaging (MRI) apparatus, X-ray diagnostic apparatus, ultrasound diagnostic apparatus, etc.

In addition, such a medical image diagnostic apparatus includes an apparatus such as a multi-slice X-ray CT system that can carry out high-definition (high resolution) imaging over a wide range per unit time. This multi-slice X-ray CT system uses a two-dimensional detector of a configuration having detector elements of m channels×n rows (m, n are positive integers) in total, wherein a plurality of rows (for example, 4 rows, 8 rows, etc.) of detector (1 row) used for a single-slice X-ray CT system is arranged in a direction orthogonal to these rows.

Due to such a multi-slice X-ray CT system, the larger a detector is (the greater the number of detector elements configuring the detector), the greater the possibility of acquiring projection data over a wider region in a single image. In other words, by temporarily imaging using a multi-slice X-ray CT system provided with such a detector, it is possible to generate volume data for a specific site at a high frame rate (hereinafter, sometimes referred to as a “Dynamic Volume scan”). This makes it possible for an operator to assess the movement of the specific region within a unit of time by means of three-dimensional images.

In addition, a medical image processing apparatus exists that generates medical images based on image data obtained by such a medical image diagnostic apparatus (for example, volume data reconstructed by an X-ray CT system).

### BRIEF DESCRIPTION OF THE DRAWINGS

FIG. 1 illustrates the configuration of a medical image processing apparatus according to the present embodiment.

FIG. 2 illustrates the movement of an observation object over time.

FIG. 3A explains the analysis of the positional relation of bones.

FIG. 3B explains the analysis of the positional relation of bones.

FIG. 3C explains the analysis of the positional relation of bones.

FIG. 3D explains the analysis of the positional relation of bones.

FIG. 3E explains the analysis of the positional relation of bones.

FIG. 3F explains the analysis of the positional relation of bones.

FIG. 4 is a flow chart showing a series of operations of the medical image processing apparatus according to the present embodiment.

### DETAILED DESCRIPTION

The purpose of this embodiment is to provide a medical image processing apparatus capable of easily assessing the motion of other sites based on a specific site in the event of assessing the motion of a flexible site configured by a plurality of sites.

The present embodiment pertains to a medical image processing apparatus comprising storage, a reconstruction processor, an extracting part, an analyzing part, an image processor, a display, and a display controller. The storage stores three-dimensional image data at a plurality of timing points indicating a flexible site constructed by a plurality of sites of a biological body. The reconstruction processor subjects the projection data to reconstruction processing to generate three-dimensional image data regarding the flexible site for each of a plurality of timing points. The extracting part extracts a plurality of construction sites constructing the flexible site from the image data. The analyzing part calculates positional information indicating the position of the first site in the plurality of construction sites extracted from the image data at the first timing point, as well as the position of the first site extracted from the image data at the second timing point. The image processor generates a plurality of medical images indicating changes over time in the relative position of the second site in the plurality of construction sites to the first site based on the positional information. The display controller causes a display to display the plurality of medical images along the time sequence.

### Embodiment 1

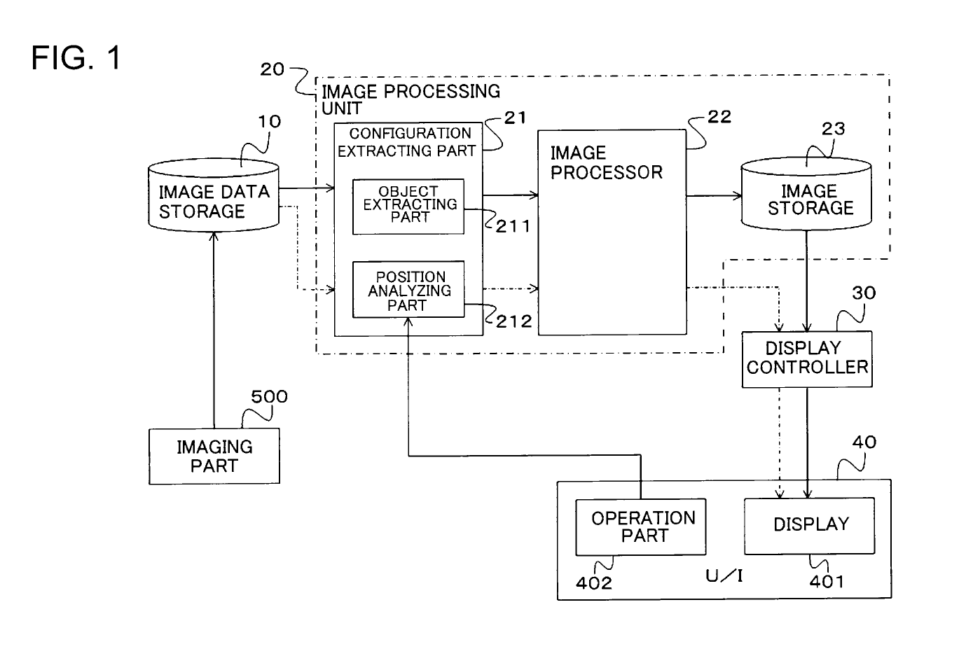

The medical image processing apparatus according to the first embodiment generates medical images based on the image data (for example, volume data) obtained by a medical image diagnostic apparatus such an X-ray CT system. Hereinafter, the configuration of the medical image processing apparatus according to the present embodiment will be described with reference to FIG. 1. As illustrated in FIG. 1, the medical image display according to the present embodiment includes image data storage 10, an image processing unit 20, a display controller 30, and a U/I40. In addition, the U/I40 is a user interface including a display 401 and an operation part 402.

### (Image Data Storage 10)

The image data storage 10 is storage for storing three-dimensional image data (for example, volume data) of a plurality of timing points obtained by imaging a subject in each examination by an imaging part 500. The imaging part 500 is a medical imaging apparatus capable of obtaining three-dimensional image data, for example, as with a CT, MRI, ultrasound diagnostic apparatus, etc. It should be noted that hereinafter, the three-dimensional image data is referred to as “image data.” Furthermore, hereinafter, image data is described as volume data obtained by a CT. In addition, according to the present embodiment, the image data is constructed so as to be capable of extracting bones. The flexible site is explained exemplifying a part configured by two bones as well as a joint connecting these bones. The joint is a joint connecting the bones and including joint fluid, a synovial, and a joint capsule. Further, the side of the bone connected through the joint has cartilage and by means of this cartilage, the flexible site can be smoothly moved. In other words, this bone also includes cartilage. In addition, this flexible site comprises a plurality of construction sites, and in the above case, these construction sites include two bones to be connected by the joint.

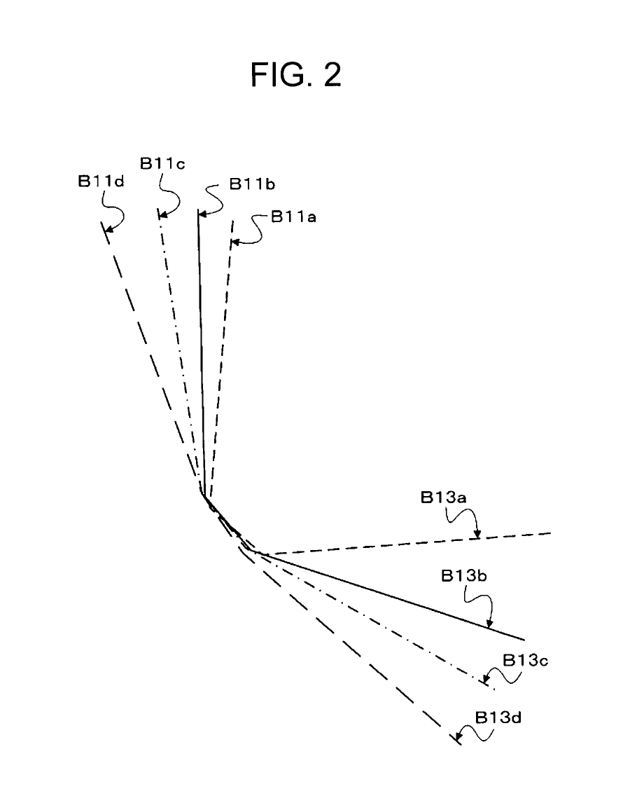

Here, FIG. 2 will be referred. FIG. 2 is a schematic diagram explaining the motion of an observation object over time. FIG. 2 illustrates the motion of an arm part over time by lines in a simulated manner when the arm part of a subject is imaged. B11a to B11d in FIG. 2 illustrate brachial regions corresponding to different timing points respectively in a simulated manner. In addition, B13a to B13d illustrate antebrachial regions corresponding to different timing points respectively in a simulated manner. The antebrachial region B13a illustrates the position of the antebrachial region at the same timing point as the brachial region B11a. In other words, the brachial region B11a and the antebrachial region B13a correspond to each other. Similarly, the brachial regions B11b to B11d and the antebrachial regions B13b to B13d correspond to each other. Hereinafter, should a particular timing point not be specified, sometimes the brachial regions B11a to B11d are simply described as “a brachial region B11”, while sometimes the antebrachial regions B13a to B13d are simply described as “an antebrachial region B13”.

As illustrated in FIG. 2, the brachial region B11 and the antebrachial region B13 work with each other, and at respective timing points, their respective positions are changed. As a result, for example, it is difficult to measure and access the displacement and the flexible range of the antebrachial region B12 based on the brachial region B11. Therefore, in the medical image processing apparatus according to the present embodiment, when measuring and accessing the movement of the observation objects with a plurality of sites working with each other over time in this way, alignment is carried out between a plurality of image data based on the position and direction of any site. Thereby, it becomes possible to easily measure and assess the change amount in the relative position and direction of another site (the second site) to the standard site (the first site). Hereinafter, the details of the operation according to this alignment will be described separately divided into “specification of a standard” and “execution of alignment”, focusing on the relative configuration.

### (Designation of Standard)

At first, the operation of respective configurations according to the specification of a standard will be described.

### (Image Processing Unit 20)

The image processing unit 20 includes a configuration extracting part 21, an image processor 22, and image storage 23.

### (Configuration Extracting Part 21)

The configuration extracting part 21 includes an object extracting part 211 and a position analyzing part 212. At first, the configuration extracting part 21 reads image data from the image data storage 10 for each timing point. The configuration extracting part 21 outputs all image data for each read timing point to the object extracting part 211, providing instructions to extract the object.

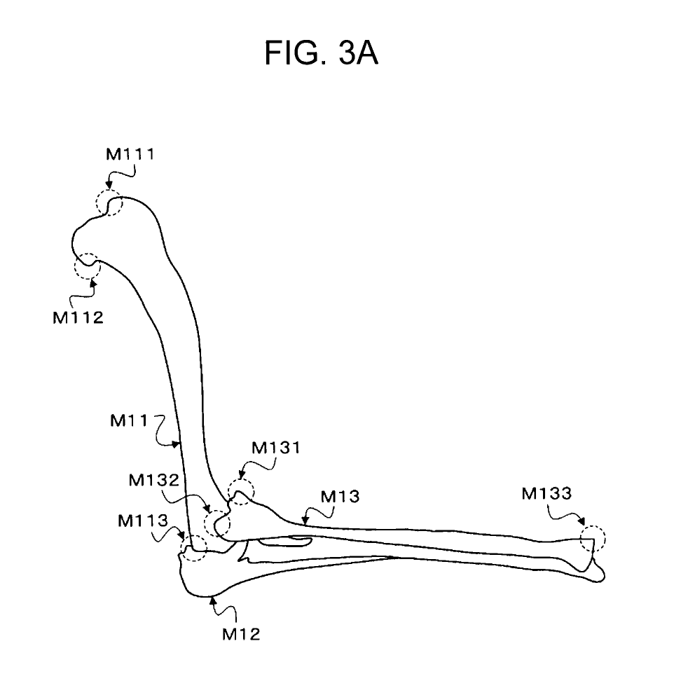

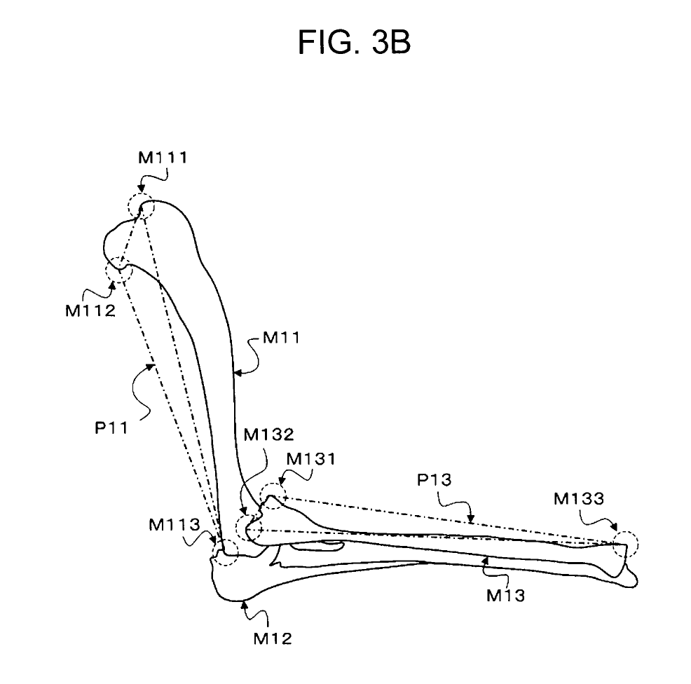

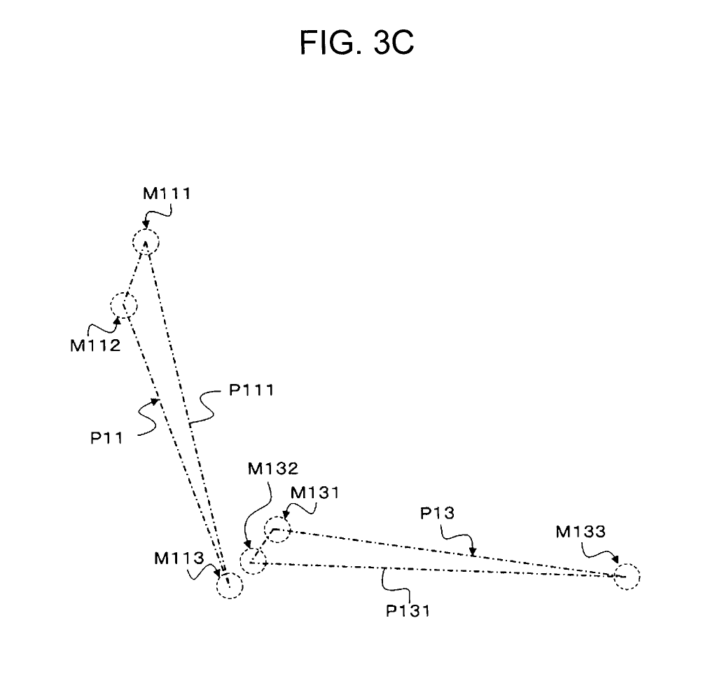

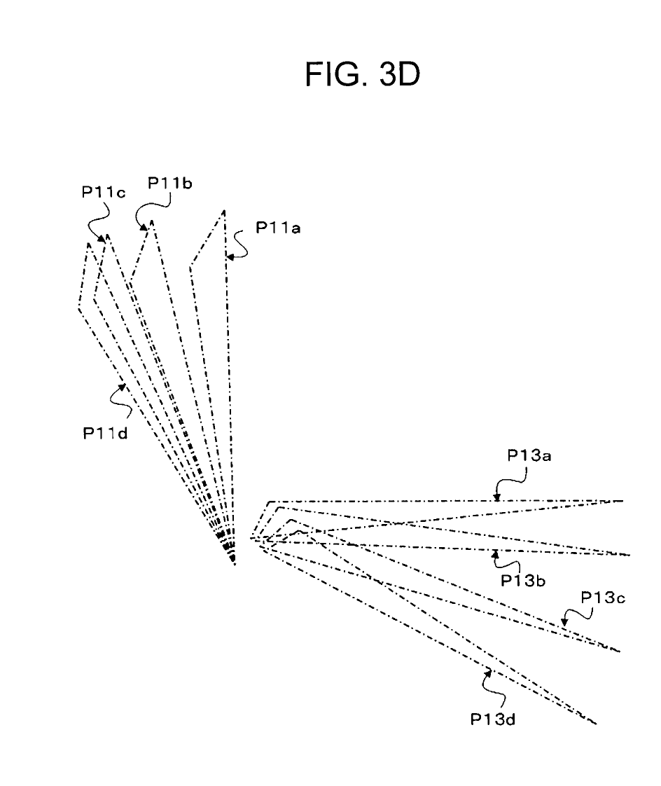

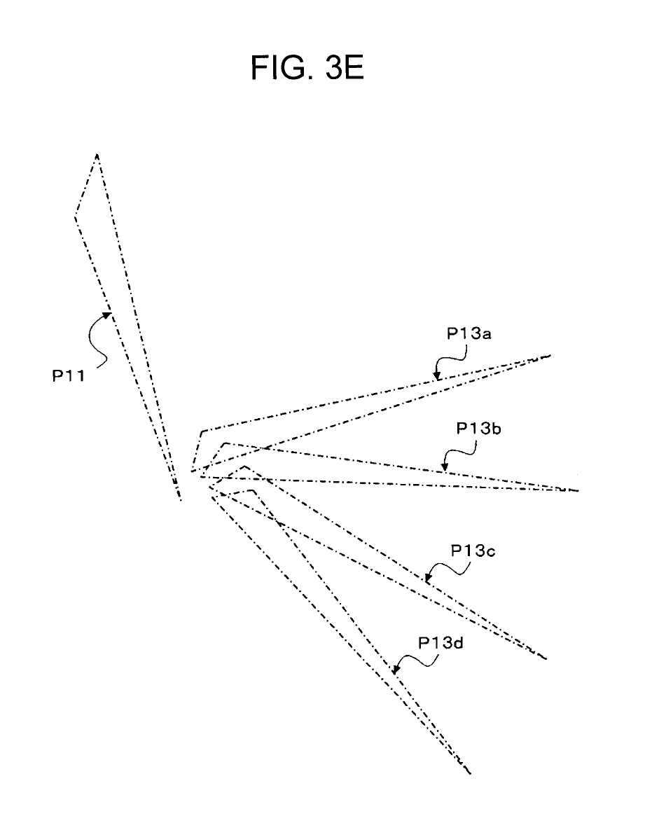

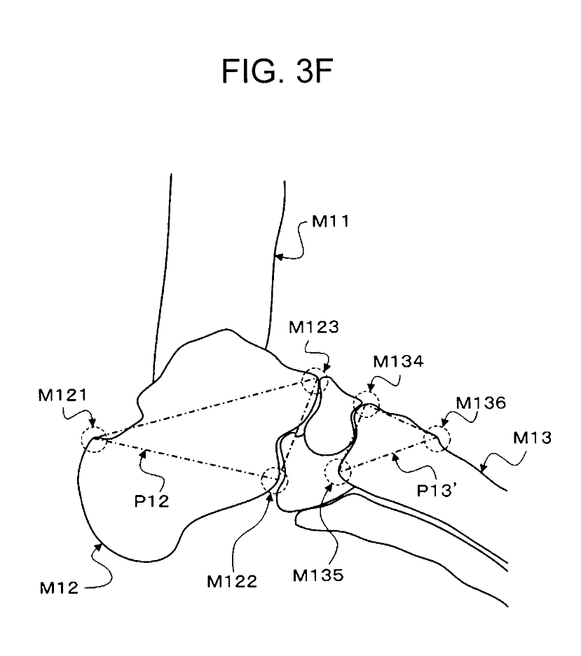

The object extracting part 211 receives image data for each timing point from the configuration extracting part 21. According to the present embodiment, the object extracting part 211 extracts bone parts and makes them into objects based on the voxel data in this image data. Here, FIG. 3A is referred. FIG. 3A is a view for explaining analysis of the positional relation in bones, and illustrates an example when bone objects forming arm regions are extracted. As illustrated in FIG. 3A, the object extracting part 211 extracts bone objects M11, M12, and M13, forming arm regions from the image data. Thus, the object extracting part 211 extracts the bone objects for all image data at each timing point. The object extracting part 211 outputs image data for each timing point and information indicating bone objects (for example, information indicating the form, the position, and the size of the object) extracted from each timing point (in other words, extracted at each timing point) to the position analyzing part 212, while relating them to each other. Further, the object extracting part 211 corresponds to “an extracting part”. In addition, the position analyzing part 212 will be described later as the operation according to “execution of alignment”.

In addition, the object extracting part 211 outputs the image data corresponding to predetermined timing points to the image processor 22 together with information indicating the bone objects extracted from this image data. Due to this information indicating the bone objects, the image processor 22 is capable of generating medical images on which respective bones in the image data are displayed so as to be capable of being identified. Further, if respective bones can be identified, information to be output to the image processor 22 together with the image data is not limited to this information indicating the bone objects. For example, supplementary information for identifying the bones may be related to the position corresponding to each bone in the image data.

### (Image Processor 22)

The image processor 22 receives, from the object extracting part 211, image data corresponding to specific timing points and the information indicating the bone objects extracted from this image data. The image processor 22 generates medical images by subjecting the image data to image processing based on predetermined image processing conditions. If medical images are generated, based on the information indicating the bone objects, the image processor 22 identifies the positions, directions, and sizes of respective bones, and identifies the regions of respective bones in the generated medical images. The image processor 22 relates the information indicating the identified respective regions with the information indicating the bone objects corresponding to this region. Thereby, by specifying the region in the medical images, it is possible to identify the bone objects corresponding to this region. The image processor 22 outputs to the display controller 30 medical images with the regions of respective bone objects specified together with the information indicating this region.

### (Display Controller 30)

The display controller 30 receives, from the image processor 22, medical images and information indicating the regions of the bone objects included in these medical images. The display controller 30 causes a display 401 to display respective regions included in the medical images such that they are capable of being specified. Thereby, by specifying a desired region in the medical images through an operation part 402, the operator can specify the bone objects corresponding to the region as an object to be a standard for alignment. Upon receiving specification of the region in the medical images from the operator, the operation part 402 notifies the position analyzing part 212 regarding information indicating the bone objects related to this region.

### (Execution of Alignment)

Next, the operations of respective configurations according to the embodiment of alignment will be described.

### (Position Analyzing Part 212)

The position analyzing part 212 receives, from the object extracting part 211, image data of each timing point with the information indicating the bone objects related. In addition, the position analyzing part 212 receives information indicating the bone objects specified by the user from the operation part 402.

At first, the position analyzing part 212 identifies the bone objects notified from the operation part 402 among bone objects M11, M12, and M13 illustrated in FIG. 3A as a standard object. Hereinafter, this will be described assuming that the object M11 corresponding to the brachial region is identified as the standard object.

If the standard object M11 is identified, the position analyzing part 212 extracts at least three portions having characteristics in its shape (hereinafter, referred to as “shape characteristics”) from this standard object M11. For example, as illustrated in FIG. 3A, the position analyzing part 212 extracts the shape characteristics M111, M112, and M113 from the object M11.

Next, the position analyzing part 212 forms planes for representing the positions and directions of respective objects in a simulated manner by portions (namely, points) indicating the extracted three shape characteristics, relating the plane with an object that is the origin for extracting the shape characteristics. Here, FIG. 3B will be referred. FIG. 3B is a view explaining the analysis of the positional relation of the bones, and FIG. 3B illustrates the planes formed based on the shape characteristics formed by the objects M11 and M13, respectively. As illustrated in FIG. 3B, the position analyzing part 212 forms a plane P11 according to shape characteristics M111, M112, and M113, relating this plane with the object M11.

Here, FIG. 3C will be referred. FIG. 3C is a view explaining the analysis of the positional relation of bones and illustrates an example in which the positional relation between the objects M11 and M13 illustrated by FIG. 3A and FIG. 3B is represented by planes P11 and P13.

When the joint is moved, the position and direction of each of a plurality of bones constructing the joint and their relative positional relations (hereinafter, sometimes they are simply referred to as “positional relations”); however, the shape and the size of each bone are not changed. In other words, the objects M11 and M13 extracted at each timing point change in their positional relation along the time sequence; however, the shape and the size of each object are not changed. The same applies to the planes P11 and P13 extracted based on the shape characteristic of each object. According to the present embodiment position, using this characteristic, the analyzing part 212 identifies the position and the direction of the position and the direction of the standard object M11 that is the standard for alignment based on the position and the direction of the plane P11. Thus, by forming a plane from the object, there is no need to carry out analysis of a complete shape in order to grasp the position and direction of the object, making it possible to reduce the processing load.

Hereinafter, in order to clearly explain changes in the relative position of the other object M13 associated with alignment based on the standard object M11, as illustrated in FIG. 3B, the position and direction of the other object M13 will be explained by means of the plane P13 by simulation. Moreover, the plane P13 is formed by the shape characteristics M131, M132, and M133 of the object M13 as illustrated in FIGS. 3A to 3C. Further, in order to carry out alignment among the image data, the position analyzing part 212 forms a plane P11 with regard to the standard object M11 only.

Thus, based on the plane P11 extracted at each timing point, the position analyzing part 212 identifies the position and direction of the object M11 at each timing point. Here, FIG. 3D will be referred. FIG. 3D is a view explaining the analysis of the positional relation of the bones and illustrates an example of the positional relation between the planes P11 and P13 at plural timing points. P11a to P11d in FIG. 3D illustrate the plane P11 corresponding to different timing points, respectively. In addition, P13a to P13d illustrate the plane P13 corresponding to different timing points, respectively. The plane P13a indicates the position of the bone object M13 at the same timing point as the plane P11a. In other words, the plane P11a and the plane P13a correspond with each other. In the same manner, the planes P11b to P11d and the planes P13b to P13d correspond to each other, respectively. Further, any of these different timing points corresponds to “the first timing point,” while the other timing point corresponds to “the second timing point.”

As illustrated in FIG. 3D, the planes P11 and P13 (namely, the bone objects M11 and M13) work with each other, and at each timing point, the respective positions are changed. Therefore, as illustrated in FIG. 3D, it is difficult to measure and access the displacement and the flexible range of other planes based on one plane (for example, the plane P13 based on the plane P11).

Therefore, the position analyzing part 212 calculates positional information for alignment among the image data for each timing point such that the plane P11 corresponding to the standard object M11 is located at the same position for each timing point (such that the relative positions coincide with each other). As a specific example, the position analyzing part 212 calculates the relative coordinate system for each set of image data based on the position and the direction of the plane P11. Thereby, for example, by carrying out alignment such that the axis of this relative coordinate system is identical among respective image data, the position and the direction of the plane P11, namely, the position and direction of the bone objects M11, are always constant. In other words, by carrying out alignment and generating medical images for each timing point based on this calculated positional information, when respective medical images are displayed along the time sequence, it is possible to display the relative motion of the other site based on the site corresponding to the object M11.

In addition, the position and direction of the other object M13 to the standard object M11 can be identified as coordinates on the calculated relative coordinate system. For example, FIG. 3E illustrates the state after alignment that allows the positions and directions of the planes P11a to P11d to coincide with each other starting from the state illustrated in FIG. 3D. FIG. 3E illustrates the positions of the planes P11a to P11d as “the plane P11”. As illustrated in FIG. 3E, by alignment that allows the positions and directions of the plane P11 to coincide for each timing point, it is possible to easily recognize the displacement and the flexible range of the other object M13 (plane P13) based on the plane P11 (standard object M11). In other words, by alignment in this way, the displacement and the flexible range of the other object M13 based on the standard object M11 can be easily measured and assessed.

Further, if alignment can be carried out such that the position and direction of the standard object M11 are always constant among respective image data, the alignment method is not limited to the above-described method for calculating the relative coordinate system. For example, alignment may be carried out by calculating displacement in the position and direction of the standard object M11 in the absolute coordinate system among respective image data, and carrying out coordinate conversion based on this displacement. Hereinafter, the embodiment will be described assuming that alignment is carried out among respective image data by calculating the relative coordinate system.

In addition, the position analyzing part 212 is not limited to the above-described method based on the plane P11 if the position and direction of the standard object M11 can be identified. For example, the position and the direction of the standard object M11 may be identified based on the outline of the standard object M11. In this case, the position analyzing part 212 identifies a three-dimensional positional relation. In addition, for two-dimensional alignment, it is possible to extract from the standard object M11 a line connecting at least two shape characteristics, and to identify the position and direction of the standard object M11 based on the extracted line. For example, as illustrated in FIG. 3C and FIG. 3D, a line P111 is extracted based on the shape characteristics M111 and M113. The position analyzing part 212 can identify the two-dimensional position and direction of the object M11 based on the extracted line P111. In addition, the position and direction may be identified by alignment of the object itself based on pixel value information from the voxel constituting an object using Mutual Information. For example, based on the distribution of the pixel value information (information showing shading), it is possible to identify the position and direction of the object.

In addition, an example in which a bone object specified by the operator is defined as the standard object is described above; however, the position analyzing part 212 may be operated so as to automatically determine the standard object. In this case, the position analyzing part 212 stores the biological body information of respective parts constructing the known biological body (for example, the information indicating the positional relation of the bones constructing the brachial region and the antebrachial region), and it may identify a standard object based on this biological body information. Further, as another method, the position analyzing part 212 stores the information indicating the shape of the standard object in advance, and it may identify an object that coincides with this shape as the standard object.

In addition, if the positional relation of the bones can be analyzed, it is not always necessary for the whole images of respective bones such as the image of the brachial region and the image of the antebrachial region to be taken as illustrated in FIGS. 3A to 3C. For example, FIG. 3F illustrates the joint between the brachial region and the antebrachial region, and this example indicates an example in which the object M12 or the object M13 is identified as the standard object. In this case, for example, when the object M12 is defined as the standard, the position analyzing part 212 extracts the shape characteristics M121, M122, and M123 from the object M12. The position analyzing part 212 may form a plane P12 formed of the shape characteristics M121, M122, and M123. In addition, when the object M13 is defined as the standard, the position analyzing part 212 extracts the shape characteristics M134, M135, and M136 from the object M13. The position analyzing part 212 may form a plane P13′ formed of the shape characteristics M134, M135, and M136. Thus, if the position and direction of a specific bone can be recognized based on the shape characteristics, even when the whole images of respective sites are not taken as illustrated in FIG. 3F, processing can be carried out in the same manner as above.

As described above, the position analyzing part 212 calculates a relative coordinate system regarding each set of image data for each timing point based on the position and direction of the plane P11. When the relative coordinate system is calculated with respect to a series of timing points, the position analyzing part 212 attaches the information indicating the calculated relative coordinate system (hereinafter, referred to as “positional information”) to the image data corresponding to the standard object M11 (namely, plane P11) that is a calculation origin, and outputs this to the image processor 22.

### (Image Processor 22)

An image processor 22 receives from the position analyzing part 212 a series of image data reconstructed for each specific timing point with the positional information attached. The image processor 22 extracts the positional information attached to respective image data and carries out alignment among respective image data based on this positional information. In other words, the image processor 22 carries out alignment such that the axes of the relative coordinate system coincide with each other among respective image data. After alignment among the image data, the processor 22 generates medical images respectively by subjecting respective image data to the image processing based on the predetermined image processing conditions. The image processor 22 causes image storage 23 to store the generated medical images and the information indicating a timing point corresponding to image data as a generation origin to be associated with each other. The image storage 23 is storage that stores the medical images.

### (Display Controller 30)

When medical images are generated for a series of timing points, the display controller 30 reads a series of medical images stored in the image storage 23. With reference to the information indicating the timing point attached to read respective medical images, the display controller 30 arranges these series of medical images along the time sequence to generate motion images. The display controller 30 causes the display 401 to display the generated motion image. Here, as the case of displaying respective medical images along the time sequence, it is possible to display respective medical images by the motion images. In addition, it is possible to superimpose respective medical images for each time sequence medical image to be displayed as a static image.

With reference to FIG. 3D in order to explain the display of each time sequence, as indicated in the order of P11a and P13a at the first timing point and P11b and P13b, at the second timing point . . . , the objects M11 and M13 for each timing point are obtained. Then, as illustrated in FIG. 3E, with respect to the position of P11, the object is adjusted in the order of P13a, P13b, P13c, and P13d.

According to the display of the motion image, the motion image of the object M13 is displayed at the position of P11, with the remaining object M11 displayed, in the order of P13a, P13b, P13c, and P13d. In addition, according to another example of displaying each time sequence, the remaining object M11 is displayed to be superimposed on all of the positions of P11, P13a, P13b, P13c, P13d. Since the object M13 is obtained for each of P13a, P13b, P13c, P13d at a different time, the case of displaying with superimposing is included in the display in the time sequence.

Further, in the above-described embodiment, an example is provided in which the medical images (images of bones) are displayed with image processing carried out on the image data; however, for example, the planes extracted from respective bone objects as illustrated in FIG. 3E (for example, plane P11 and P13) may be displayed. Thus, by presenting respective bones using figures with a simple shape by simulation, the operator can easily measure the change amounts of the temporal positions and directions of respective bones (namely, the movement amount) and the flexible range of the peripheral construction.

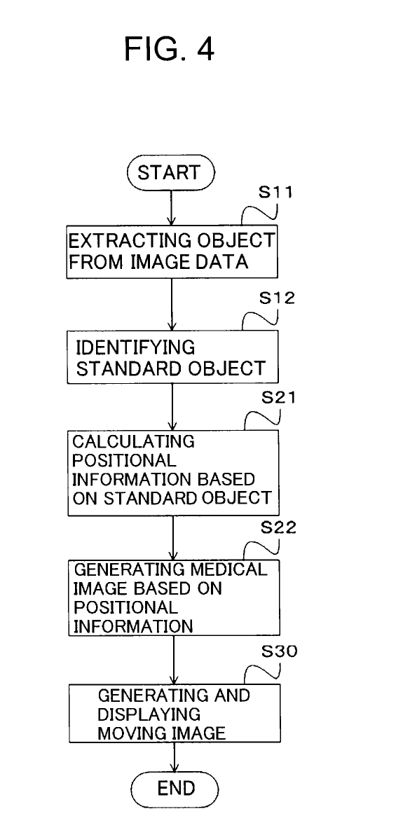

Next, with reference to FIG. 4, a series of operations of the medical image processing apparatus according to the present embodiment will be described. FIG. 4 is a flow chart showing a series of operations of the medical image processing apparatus according to the present embodiment.

### (Step S11)

The object extracting part 211 receives the image data for each timing point from the configuration extracting part 21. According to the present embodiment, the object extracting part 211 extracts the bones as the object based on the voxel data in this image data. Here, FIG. 3A will be referred. As illustrated in FIG. 3A, the object extracting part 211 extracts the bone objects M11, M12, and M13 forming arm regions from the image data. Thus, the object extracting part 211 extracts the bone objects for the image data for each timing point. The object extracting part 211 associates the image data for each timing point with the information indicating the bone objects (for example, the information indicating the shape, the position, and the size of the object) extracted from each set of image data (namely, extracted for each timing point) to be output to the position analyzing part 212.

### (Step S12)

In addition, the object extracting part 211 outputs the image data corresponding to a predetermined timing point to the image processor 22 together with the information indicating the bone objects extracted from this image data. Due to this information indicating the bone objects, the image processor 22 can generate medical images displaying respective bones in the image data so as to be capable of being identified. Further, if respective bones can be identified, the information to be output to the image processor 22 together with the image data is not limited to this information indicating the bone objects. For example, the associated information for identifying the bones may be related to the positions corresponding to respective bones in the image data.

The image processor 22 receives image data corresponding to specific timing points and the information indicating the bone objects extracted from this image data from the object extracting part 211. The image processor 22 generates medical images by subjecting the image data to image processing based on predetermined image processing conditions. If medical images are generated, based on the information indicating the bone objects, the image processor 22 identifies the positions, directions, and sizes of respective bones, and identifies the regions of respective bones in the generated medical images. The image processor 22 relates the information indicating the identified respective regions with the information indicating the bone objects corresponding to this region. Thereby, by specifying the region in the medical images, it is possible to identify the bone objects corresponding to this region. The image processor 22 outputs medical images, with the regions of respective bone objects identified, to the display controller 30 together with the information indicating this region.

The display controller 30 receives medical images and information indicating the regions of the bone objects included in these medical images from the image processor 22. The display controller 30 causes a display 401 to display respective regions included in the medical images so as to be capable of being specified. Thereby, the operator can specify the bone objects corresponding to the region as objects that are the standard for alignment by specifying a desired region in the medical images through an operation part 402. Upon receiving the specifications of the region in the medical images from the operator, the operation part 402 notifies the position analyzing part 212 of information indicating the bone objects related to this region.

For each timing point, the position analyzing part 212 receives, from the object extracting part 211, image data with the information indicating the bone objects related. In addition, the position analyzing part 212 receives, from the operation part 402, information indicating the bone objects specified by the user.

At first, the position analyzing part 212 identifies the bone objects notified from the operation part 402 among bone objects M11, M12, and M13 illustrated in FIG. 3A as standard objects. Hereinafter, this will be described assuming that the object M11 corresponding to the brachial region is identified as the standard object.

### (Step S21)

If the standard object M11 is identified, the position analyzing part 212 extracts at least three portions having characteristics in its shape (hereinafter, referred to as “shape characteristics”) from this standard object M11. For example, as illustrated in FIG. 3A, the position analyzing part 212 extracts the shape characteristics M111, M112, and M113 from the object M11.

Next, the position analyzing part 212 forms planes for grasping the positions and directions of respective objects by simulation by portions (namely, points) indicating the extracted three shape characteristics, relating the plane with the object that is the origin for extracting the shape characteristics. Here, FIG. 3B will be referred. FIG. 3B is a view explaining the analysis of the positional relation of the bones, and FIG. 3B illustrates the planes formed based on the shape characteristics formed by the objects M11 and M13, respectively. As illustrated in FIG. 3B, the position analyzing part 212 forms a plane P11 according to shape characteristics M111, M112, and M113, relating this plane with the object M11.

Thus, based on the plane P11 extracted at each timing point, the position analyzing part 212 identifies the position and direction of the object M11 at each timing point.

Here, FIG. 3D will be referred. As illustrated in FIG. 3D, the planes P11 and P13 (namely, bone objects M11 and M13) work with each other, and at each timing point, respective positions are changed. Therefore, as illustrated in FIG. 3D, it is difficult to measure and access the displacement and the flexible range of the other plane based on one plane (for example, the plane P13 based on the plane P11).

Therefore, the position analyzing part 212 calculates positional information for alignment among the image data for each timing point such that the plane P11 corresponding to the standard object M11 is located at the same position for each timing point (such that the relative positions coincide with each other). As a specific example, the position analyzing part 212 calculates a relative coordinate system for each set of image data based on the position and the direction of the plane P11. Thereby, for example, by carrying out alignment such that the axis of this relative coordinate system is identical among respective image data, the position and direction of the plane P11, namely, the position and direction of the bone objects M11 are always constant. In other words, by carrying out alignment and generating medical images for each timing point based on this calculated positional information, when respective medical images are displayed along the time sequence, it is possible to display the relative motion of the other site based on the site corresponding to the object M11.

As described above, the position analyzing part 212 calculates a relative coordinate system regarding each set of image data for each timing point based on the position and direction of the plane P11. When the relative coordinate system is calculated with respect to a series of timing points, the position analyzing part 212 attaches the information indicating the calculated relative coordinate system (hereinafter, referred to as “positional information”) to the image data corresponding to the standard object M11 (namely, plane P11) that is a calculation origin and outputs this to the image processor 22.

### (Step S22)

The image processor 22 receives, from the position analyzing part 212, a series of image data reconstructed for each specific timing point with the positional information attached. The image processor 22 extracts the positional information attached to respective image data and carries out alignment among respective image data based on this positional information. In other words, the image processor 22 carries out alignment such that the axes of the relative coordinate system coincide with each other among respective image data. When alignment among the image data is carried out, the processor 22 generates medical images respectively by subjecting respective image data to the image processing based on the predetermined image processing conditions. The image processor 22 cause the image storage 23 to store the generated medical images and the information indicating a timing point corresponding to image data as a generation origin while relating them with each other.

### (Step S30)

When medical images are generated for a series of timing points, the display controller 30 reads a series of medical images stored in the image storage 23. With reference to the information indicating the timing point attached to read respective medical images, the display controller 30 arranges this series of medical images along the time sequence to generate motion images. The display controller 30 causes the display 401 to display the generated motion images. Here, as the case of displaying respective medical images along the time sequence, it is possible to display respective medical images by the motion images. In addition, it is possible to superimpose respective medical images for each time sequence medical image to be displayed as a static image.

As described above, according to the present embodiment, the medical image processing apparatus analyzes changes in the positional relation of at least two sites that temporarily work with each other such as a joint by means of the bone objects corresponding to these sites. In addition, the medical image processing apparatus carries out alignment such that the positions and directions of one bone object among the bone objects corresponding to a plurality of sites (namely, standard object) coincide with each other at each timing point. Thereby, in the event of assessing the movements of the observation objects of a plurality of sites temporarily working with each other, it becomes possible to easily assess the movement of the other sites based on the specific site.

The above description has set forth an example of bones as the flexible sites, while the same cases may be applied to muscles or tendons. In this case, objects are formed with regard to each muscle tissue to determine the positional relations between the objects over time series just as set forth as above.

The case of tendons is also same as the case of muscles. The positional relation of tendons may be determined by forming objects just as the case of muscles. Particularly, tissues close to bones, among the tendons such as ligaments connecting bones, may be transformed into objects so as to determine a positional relation between objects of tendons and bones over time series.

Furthermore, the positional relation of components of the flexible site such as bones, etc. was described using the 2-dimensional positional relation between two bones as an example; however, the positional relation may be 3-dimensionally shaped in some cases. The example described a case when the first bone is pointing up and the second bone is pointing right, and when the second bone is pointing to the upper right with respect to this. However, a case may be considered in which the movement of the bone shifts in the rotational direction by adding a twist, etc., in addition to the movement in the 2-dimensional direction. A case may also be considered in which the position of the second bone does not move with respect to the first bone regardless of the rotation of the second bone. Accordingly, the positional relation of the components of the flexible site may be 3-dimensionally comprehended, the movement in the 3-dimensional rotational direction may be obtained from among the changes in the shape characteristics of three points and the shape feature of two points, thereby the amount of change in the positional relation is also obtained regarding the twisting, and the determination process with respect to the amount of change may be carried out. The determination process itself with respect to the amount of change is the same as in the case of the 2-dimensional positional relation.

In the above-described embodiments, as a flexible site, bones and joints are exemplified; however, as a flexible site, it is also possible to focus on cartilage. For example, the abovementioned process may be carried out by identifying three points of shape features regarding cartilage and two shape features instead of identifying three points of shape features regarding the bones. As a merit of analyzing cartilage as a flexible site in place of a bone, improved diagnosis accuracy of disc hernias can be cited. Disc hernias occur due to the protrusion of cartilage in the joints.

Acquiring image data of cartilage by means of a medical imaging apparatus, the positional relationship of cartilage is analyzed in the same manner as the above-described positional relationship of the bones. Disc herniation is present if there is protrusion of cartilage in the joints; therefore, the diagnosis result may be obtained without having to wait for an analysis of the bone. This analysis processing can be carried out in place of analysis processing regarding the bones; however, the analysis processing can be carried out together with analysis processing regarding the bones. When acquisition and analysis of images are carried out in parallel with processing of the bones and it is found that a disk hernia has occurred from analysis results regarding images of the cartilage, by completing analysis without waiting for analysis of the bones, it is possible to acquire an accurate diagnosis at an earlier stage. Further, other than the case in which cartilage protrudes, the case in which cartilage is crushed by sites such as other bones is also considered; in this case also, when cartilage is crushed more than a certain extent, the crushing is defined as an analysis result, and based on this result.

While certain embodiments have been described, these embodiments have been presented by way of example only, and are not intended to limit the scope of the inventions. Indeed, the novel systems described herein may be embodied in a variety of their forms; furthermore, various omissions, substitutions and changes in the form of the systems described herein may be made without departing from the spirit of the inventions. The accompanying claims and their equivalents are intended to cover such forms or modifications as would fall within the scope and spirit of the inventions.

What is claimed is:

1. A medical image processing apparatus, comprising:
storage configured to store three-dimensional image data at a plurality of timing points indicating a flexible site constructed by a plurality of sites of a biological body,
an extracting part configured to extract a plurality of construction sites constructing the flexible site from each of the image data,
an analyzing part configured to calculate positional information indicating the position of the first site among the plurality of construction sites extracted from the image data at the first timing point, and the position of the first site extracted from the image data at the second timing point,
an image processor configured to generate a plurality of medical images indicating changes over time in the relative position of the second site in the plurality of construction sites to the first site based on the positional information, and
a display controller configured to cause a display to display the plurality of medical images along time sequence.

2. The medical image processing apparatus according to claim 1,
wherein the site includes bones,
the extracting part respectively extracts the bones, and
the analyzing part carries out alignment such that the positions of one bone among a plurality of the extracted bones coincide with each other among the image data at different timing points.

3. The medical image processing apparatus according to claim 2,
wherein the analyzing part forms a plane based on three or more shape characteristics regarding each of the bones, and carries out the alignment based on the positions of the formed planes.

4. The medical image processing apparatus according to claim 2,
wherein the analyzing part forms lines based on two or more shape characteristics regarding each of the bones, and carries out the alignment based on the positions of the formed lines.

5. The medical image processing apparatus according to claim 2,
wherein the analyzing part carries out the alignment based on the outline of the one bone.

6. The medical image processing apparatus according to claim 2,
wherein the analyzing part carries out the alignment based on the information indicating shading of the one bone.

7. The medical image processing apparatus according to claim 1,
wherein the display controller causes the display to display the plurality of medical images indicating changes over time in the relative position of the second site while superimposing the medical images on one screen.

8. The medical image processing apparatus according to claim 1,
wherein the display controller causes the display to display motion images of the plurality of medical images indicating changes over time in the relative position of the second site.
